(19) United States
(12) Patent Application Publication
(10) Pub. No.: US 2004/0147187 A1
(43) Pub. Date: Jul. 29, 2004

(54) Elastically deformable fabric with gel coated surface

(76) Inventor: Allen C. Rasor SR., Arroyo Grande, CA (US)

Correspondence Address: Michael G. Petit, P.O. Box 91929, Santa Barbara, CA, 93190-1929, US

(21) Appl. No.: 10/735,015

(22) Filed: Dec. 12, 2003

Related U.S. Application Data
(60) Provisional application No. 60/442,646, filed on Jan. 23, 2003.

(51) Int. Cl. B32B 27/04; B32B 5/02; B32B 27/12; B32B 5/22

(52) U.S. Cl. 442/85; 442/76; 442/181; 442/164

(57) ABSTRACT

An appliqué for the skin that includes an elastically deformable woven fabric having an imperforate, tacky gel coating on one side thereof. The fabric is preferably woven from a thread comprising an elastic polyester or polyether fiber such as Spandex. The gel coating, which is applied to one side of the fabric, is preferably silicone gel. The appliqué may be used as a wound dressing or as a drug delivery system for administering a medicament transdermally such as, for example, for scar management.

This application claims the benefit of U.S. Provisional Application No. 60/442,646, filed Jan. 23, 2003.

### BACKGROUND OF THE INVENTION

1. Field of the Invention

The present invention relates to an elastically extensible woven fabric having an elastomeric gel coating on one surface thereof.

2. Prior Art

Wound dressings are applied directly to wounded or diseased tissue for the absorption of secretion, for protection from trauma, for administration of medicine, to keep the wound clean, or to stop bleeding. Prior art dressings address such issues by providing varying degrees of wound ventilation, of hydrophobic/hydrophyllic capability, and other characteristics depending upon the immediate need. However, the effectiveness of the treatment is sometimes limited by the degree of physical contact between the skin and the dressing itself. Indeed, irregular contours of the body present a challenging topology to customarily flat medical dressings. In the case of pressure dressings, this problem is solved by means of an external wrap. However, the presence of the wrap may interfere with important functions of the dressing, such as its ventilating properties. The location of the wound may also make adequate application of an external wrap impossible. Clearly, there exists a long felt need for an elastically deformable wound dressing.

Spandex was the first manufactured elastic fiber, and was introduced by Dupont under the tradename Lycra in 1958. Due to its improved strength and ability to hold a dye, spandex replaced extensible fabrics woven from rubber fibers in most garment applications. Spandex fiber is a long-chain synthetic polymer comprised of at least 85% segmented polyurethane. The polymer chain is a segmented block copolymer containing long, randomly coiled, liquid soft segments that move to a more linear, lower entropy structure. The hard segments act as “virtual cross-links” that tie all the polymer chains together into an infinite network. This network prevents the polymer chains from slipping past each other and taking on a permanent set or draw. When the stretching force is removed, the linear, low entropy, soft segments move back to the preferred randomly coiled, higher entropy state, causing the fiber to recover to its original shape and length. The segmented block copolymer is extruded into a fiber comprised of a plurality of coalesced fine filaments. The fibers are woven to provide an extensible fabric.

The size and density of the interstices in the fabric depend on the “thread count” and can generally be varied in the weaving process. Topical dressings such as wound dressings in the form of both perforate and imperforate elastomeric sheets, one side of which has a gel coated thereon, are well known in the art. Nonextensible woven fabrics having one side coated with a gel are also known. Examples of such prior art dressings are disclosed in U.S. Pat. Nos. 4,991,574 and 4,838,253. Fabo, in U.S. Pat. No. 5,340,363, discloses a liquid-permeable wound dressing comprising a mesh net of a reinforcing fabric wherein the adjacent fibers defining the interstices of the fabric are impregnated with an elastic hydrophobic gel such as silicone gel but the interstices contain openings to permit fluid to flow through the dressing. Surprisingly, no dressings for topical application have been described wherein the dressing comprises a sheet of fabric woven from elastic fibers and having interstices therein wherein one side of the fabric is coated with an imperforate layer of a hydrophobic gel to occlude the interstice openings and provide a tacky adhesive surface and wherein the opposing surface of the fabric is uncoated and retains the texture and feel of the fabric.

### SUMMARY

It is an object of the present invention to provide a sheet comprising a fabric woven from elastically extensible fibers having an imperforate coating of a hydrophobic gel coated on one surface of the fabric, the opposing surface being uncoated.

It is another object of the present invention to provide a sheet comprising a fabric woven from elastically extensible fibers having an imperforate coating of a hydrophylic gel coated on one surface of the fabric, the opposing surface being uncoated.

The features of the invention believed to be novel are set forth with particularity in the appended claims. However the invention itself, both as to organization and method of operation, together with further objects and advantages thereof may be best understood by reference to the following description taken in conjunction with the accompanying drawings.

### BRIEF DESCRIPTION OF THE DRAWINGS

FIG. 1 is a perspective and transverse cross-sectional view of a skin dressing in accordance with the present invention.

FIG. 2 is a plan view illustrating a process for making a skin dressing in accordance with FIG. 1.

### DESCRIPTION OF THE PREFERRED EMBODIMENTS

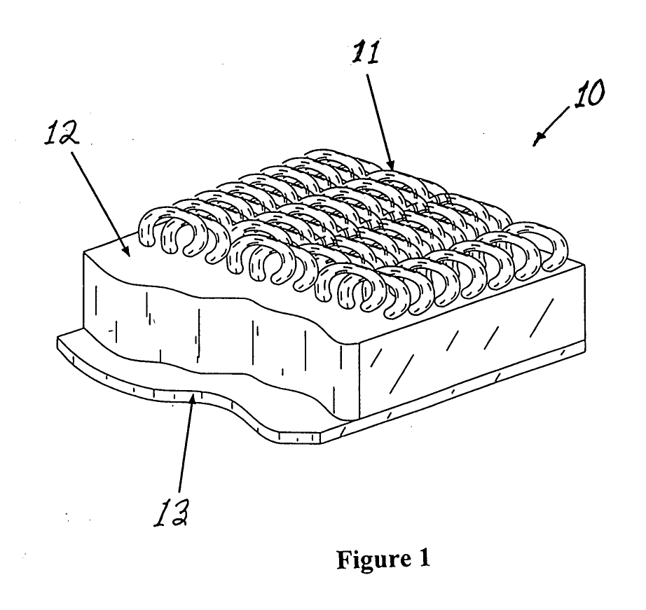

With reference to FIG. 1, a skin dressing 10 (i.e., a dressing adapted for releasable attachment to the skin), comprises a sheet of elastically extensible fabric 11 having a layer of a gel 12 such as, for example, silicone gel, coated on a lower side thereof. The term “elastically extensible fabric”, as used herein, means a fabric woven or formed from elastically extensible fibers. A carrier/release sheet of a suitable releasing material such as polycarbonate film is indicated at numeral 13 is affixed to a lower surface of the silicone gel layer in opposition to the fabric 11. The silicone gel layer 12 that covers the lower surface of the fabric 111 is continuous, impervious to liquids and does not have apertures therein. The upper surface of the fabric (i.e., the surface of the fabric opposed to the gel-covered surface) retains the texture of the fabric. The gel covered lower surface is tacky and provides adhesive means for attaching the dressing 10 to a surface. The release layer 13 protects the tacky gel layer 12 until ready for use and is peeled from the dressing to expose the gel layer prior to use.

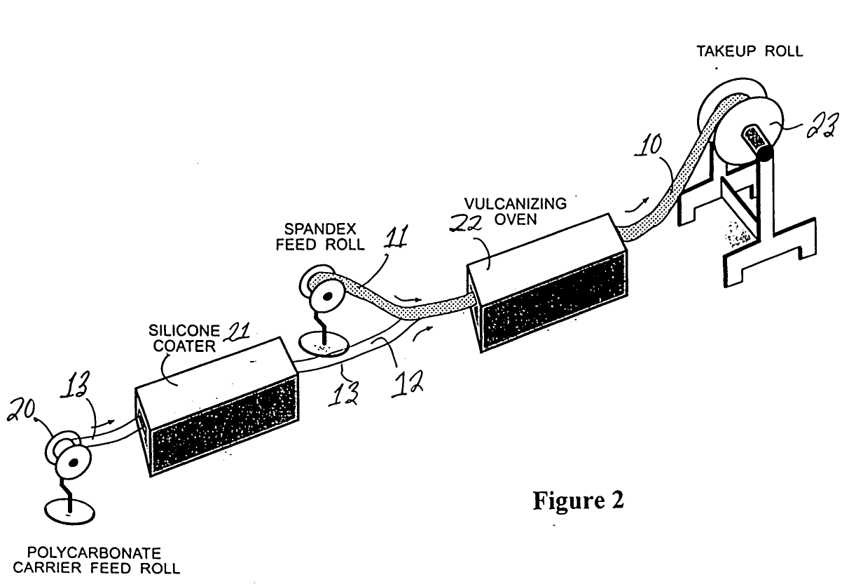

Turning now to FIG. 2, a process for fabricating the skin dressing 10 is illustrated in plan view. A release film such as a polycarbonate carrier sheet 13 is fed from a bulk roll 20, and brought into and through the gel coating application device 21, wherein the carrier sheet 13 receives a layer of unvulcanized liquid silicone gel material 12 having a predetermined thickness. Upon leaving the coating device, the Spandex fabric 11 is introduced directly onto the exposed liquid silicone gel surface 12 of the carrier sheet 13 prior to entering the heat-curing oven 22. While passing through the oven 22, the silicone gel component layer 12 is cured, or transformed by the heat into its final nonfluidic gel state. After leaving the oven 22, the bulk, finished product 10 is then rolled onto a take-up reel 23 for storage, secondary bulk cutting, or final shape cutting.

A suitable gel composition for coating the carrier sheet 13 is available as a 2-part liquid blended in a 1:1 ratio such as MED-6340 (NuSil Technology, Carpinteria, Calif. 93013). MED-6340 is supplied as a Part A and a Part B. The mixture is deaerated under vacuum prior to layering the liquid onto the carrier strip 13. The firmness of the cured gel layer can be increased by increasing the amount of Part B relative to Part A in the mixture. The gel layer is preferably heat-cured (i.e., hot-air vulcanized) by exposure to hot air at a temperature of about 300 degrees F. for 2-3 minutes in the “tunnel” oven 22. It is noted that a variety of curing conditions may be employed. The silicone gel will cure at room temperature given sufficient time.

Although the foregoing discussion relates to silicone elastomer which forms a hydrophobic gel layer, a nonelastic hydrophilic gel such as polyvinylpyrrolidone (PVP) can also be used to form the gel layer 12. Since the elasticity of the fabric permits elastic deformation of the dressing, an elastomeric gel layer, while preferable, is not necessary. The process for forming the dressing 10, when employing a hydrophilic gel as the adhesive layer, is substantially the same as the process for forming a dressing using a silicone gel, shown in FIG. 2. However, the parameters of the curing step will vary in accordance with the molecular weight of the PVP and the viscosity of the fluid applied to the carrier strip.

While particular embodiments of the present invention have been illustrated and described, it would be obvious to those skilled in the art that various other changes and modifications can be made without departing from the spirit and scope of the invention. For example, while a hydrophobic silicone gel layer is preferred, either a hydrophobic or a hydrophilic gel such as polyvinylpyrrolidone may be employed to coat one surface of the fabric. In addition, the woven fabric may comprise any elastomeric fiber provided that the fiber is elastically deformable. The described configuration could be extended to non-medical applications such as impact damping inserts for running shoes, for example. It is therefore intended to cover in the appended claims all such changes and modifications that are within the scope of this invention.

What I claim is:

1. A skin dressing comprising a fabric woven or otherwise formed from elastically extensible fibers and having intersitial openings between the fibers, said fabric having an upper surface and a lower surface wherein said lower surface is coated with an imperforate liquid-impermeable layer of a gel.

2. The skin dressing of claim 1 wherein said fabric is Spandex.

3. The skin dressing of claim 1 wherein said gel is hydrophobic.

4. The skin dressing of claim 3 wherein said gel is silicone gel.

5. A skin dressing comprising a fabric woven or otherwise formed from elastically extensible fibers and having intersitial openings between the fibers, 11 said fabric having an upper surface and a lower surface wherein said lower surface is coated with an imperforate liquid-permeable layer of a gel.

6. The skin dressing of claim 5 wherein said gel is hydrophilic.

7. The skin dressing of claim 6 wherein said gel is a hydrogel

8. The skin dressing of claim 7 wherein said hydrophilic gel comprises polyvinylpyrrolidone.
